(19) United States
(12) Patent Application Publication
(10) Pub. No.: US 2007/0179058 A1
(43) Pub. Date: Aug. 2, 2007

(54) Seed treatment pesticidal compositions

(75) Inventor: Stefan Baum, Muenchwilen (CH)

Correspondence Address: SYNGENTA CROP PROTECTION , INC.;PATENT AND TRADEMARK DEPARTMENT, 410 SWING ROAD, GREENSBORO, NC, 27409, US

(73) Assignee: SYNGENTA PARTICIPATIONS AG, Basel (CH)

(21) Appl. No.: 10/598,870

(22) PCT Filed: Mar. 15, 2005
(86) PCT No.: PCT/EP05/02755

§ 371 Date: Sep. 14, 2006

Related U.S. Application Data
(60) Provisional application No. 60/553,494, filed on Mar. 16, 2004.

(30) Foreign Application Priority Data
Jun. 2, 2004 (EP) 04013030.4

(51) Int. Cl. A01C 1/06

(52) U.S. Cl. 504/100; 47/57.6

(57) ABSTRACT

A seed treatment aqueous insecticidal and/or nematicidal composition in the form of a suspension comprising: (A) at least one insecticide and/or nematicide in an amount of at least 3 weight %, based on the weight of the composition, and optionally at least one other substance which has a melting point above 30° C.; and (B) at least two surface active compounds, wherein (i) at least one surface active compound has a molecular weight of less than 2200 and a Hydrophile-Lipophilic Balance (HLB) of at least 10 and (ii) at least one surface active compound is non-ionic, has a molecular weight of at least 2200, wherein 10 to 60% of the compound molecular weight contributes to the hydrophile constituent of the compound, and the molecular weight of the hydrophobe constituent of the compound is from 2000 to 10000; provided that the weight ratio of (B):(A) is in the range 0.08 to 0.5, and the weight ratio of (ii):(i) is at least 0.5. Such compositions demonstrate improved dust-off performance when applied to propagation material, such as seeds.

The present invention relates to an insecticidal and/or nematicidal composition and a slurry composition comprising the insecticidal and/or nematicidal composition, which compositions are used in treating plant propagation material to protect it against attack by pests; to a pest resistant plant propagation material; to a method of protecting plant propagation material; to a method of controlling pests from crop plants; and to use of certain surface active compounds for improving characteristics of the treated material.

Treatment of plant propagation material with pesticidal compositions allows protection against soil-borne pests during a susceptible stage in the plant's development. Further, systemic seed treatments may provide an alternative to the traditional foliar pesticide applications. However, following such treatment, the treated plant propagation material is handled and conveyed for packing and storage; this handling and conveying often results in the treated material brushing against each other to cause the chemicals that were bound to the material to become unbound. The release of the chemicals is often in the form of air-borne particles of, for example, pesticides and other materials from the treating composition that on drying the seed form solid particles. This can result in the treated material losing its pesticidal effectiveness and exposing workers in such treatment operations to health risks, through inhalation and sensitisation, for example, eye irritancy, of the air-borne particles.

The challenge is to improve the adherence of such particles to the plant propagation material.

It has been found that a pesticidal composition comprising certain type of surface active compounds in a defined ratio provides a reduction in the air-borne particles (commonly referred to as ‘dust’) when the treated plant propagation material, such as a seed, is handled (improved dust-off).

Accordingly, in a first aspect, the present invention provides an aqueous seed treatment insecticidal and/or nematicidal composition in the form of a suspension comprising:

(A) at least one insecticide and/or nematicide in an amount of at least 3 weight %, based on the weight of the composition, and optionally at least one other substance which has a melting point above 30° C.; and

(B) at least two surface active compounds, wherein (i) at least one surface active compound has a molecular weight of less than 2200, preferably less than 1700, such as in the range 400 to 1500, advantageously in the range 600 to 1200, and a Hydrophile-Lipophilic Balance (HLB) of at least 10, preferably in the range 10 to 25, such as 12 to 20, preferably 14 to 18 and (ii) at least one surface active compound is non-ionic, has a molecular weight of at least 2200, preferably at least 3000, such as in the range of 3500 to 15000, for example, 3500 to 10000, especially 4000 to 7500, advantageously 4500 to 6000, wherein 10 to 60, such as 15 to 55, preferably 17 to 50, %, of the compound molecular weight contributes to the hydrophile constituent of the compound, and the molecular weight of the hydrophobe constituent of the compound is from 2000 to 10000, preferably 2400 to 3900, more preferably 3000 to 3800, such as 3200 to 3700;

provided that the weight ratio of (B):(A) is in the range 0.08 to 0.5, preferably 0.1 to 0.3, advantageously 0.15 to 0.25, and the weight ratio of (ii):(i) is at least 0.5, such as at least 1.0, preferably at least 1.5, especially in the range 2 to 5, advantageously in the range 2 to 3.

In an embodiment of the first aspect, a further pesticide is also present.

In a second aspect, the present invention provides a slurry pesticidal composition (also referred to as “ready to apply” or “tank-mix”) comprising the composition of the first aspect, a liquid carrier and optionally (i) one or more, preferably other, formulation adjuvants, (ii) one or more other pesticidal compositions, each comprising at least one further pesticide, or both (i) and (ii).

In a third aspect, the present invention provides a method of protecting plant propagation material, preferably a seed, from attack by pests, such as soil-dwelling pests, preferably a nematode, by treating the material with a pesticidally, preferably a nematicidally, effective amount of the composition of the first or second aspect, preferably before planting or sowing the seed.

Accordingly, the invention also provides a method of controlling pests, such as a nematode, from damaging crop plants, especially vegetable crop plants, by the treatment of the plants' propagation material, such as a seed, with a with a pesticidally, preferably a nematicidally, effective amount of the composition of the first or second aspect, preferably before planting or sowing the seed.

In a fourth aspect, the present invention provides a pest resistant plant propagation material comprising a plant propagation material, preferably a seed, such as a vegetable seed, treated with a pesticidally, preferably nematicidally, effective amount of the composition of the first or second aspect or obtained by the method of the third aspect.

In a fifth aspect, the present invention provides the use in a first or second aspect composition, to improve the dust-off property of a plant propagation material, preferably a seed, that has been treated with the composition, of:

at least two surface active compounds, wherein (i) at least one surface active compound has a molecular weight of less than 2200 and a Hydrophile-Lipophilic Balance (HLB) of at least 10 and (ii) at least one surface active compound is non-ionic, has a molecular weight of at least 2200, wherein 10 to 85, such as 10 to 60, preferably 15 to 55, more preferably 17 to 50, %, of the compound molecular weight contributes to the hydrophile constituent of the compound, and the molecular weight of the hydrophobe constituent of the compound is from 2000 to 10000;

provided that the weight ratio of the surface active compounds to one or more pesticides, and optionally at least one other substance which has a melting point above 30° C., in the pesticidal composition or slurry composition, is in the range 0.08 to 0.5, and the weight ratio of (ii):(i) is at least 0.5.

In another aspect, the present invention provides a method of improving the dust-off property of a plant propagation material, preferably a seed, that has been treated with a first or second aspect composition, said method comprising mixing in the pesticidal or slurry composition at least two surface active compounds, wherein (i) at least one surface active compound has a molecular weight of less than 2200 and a Hydrophile-Lipophilic Balance (HLB) of at least 10 and (ii) at least one surface active compound is non-ionic, has a molecular weight of at least 2200 where the hydrophile constituent of the compound contributes to 10 to 85% of the molecular weight and the molecular weight of the hydrophobe constituent of the compound is from 2000 to 10000;

provided that the weight ratio of the surface active compounds to one or more pesticides, and optionally at least one other substance which has a melting point above 30° C., in the pesticidal composition or slurry composition, is in the range 0.08 to 0.5, and the weight ratio of (ii):(i) is at least 0.5.

The invention is described in more detail below.

Compositions

The compositions of the present invention are for treating plant propagation material, such as seeds, so that their resistance against pests is improved.

After seed treatment, the substances that can become air-borne particles have a melting point above 30° C., such substances include, for example, pesticides, colouring agents, thickening agents.

It has now been found that higher concentrations of solids (e.g., active ingredients) are able to be incorporated and maintained in satisfactory compositions according to the present invention. Accordingly, in one embodiment, the insecticide and/or nematicide (or active ingredient) is present in the composition of the first aspect in an amount of from about 12.5% to about 60% by weight, more specifically, from 30 to about 55% by weight of the composition; the balance of the composition, also known as a formulation, comprising a water along with surfactant(s) and other optional inert ingredients known in the art as formulation adjuvants, e.g., protective colloids, adhesives, thickeners, thixotropic agents, penetrating agents, preservatives, stabilizers, antifoaming agents, antifreeze agents, sequestering agents, colourings, such as dyes or pigments, and polymers.

In the composition of the second aspect, the proportions of the components would be less than that in the first aspect and depends on the amount of the liquid carrier (typically water), which is normally present in a major proportion, and also on the presence of one or more, of the same or, other formulation adjuvants and/or one or more other pesticidal compositions each comprising a further pesticide.

The pesticide or active ingredient can be of any type, for example, a fungicide, such as triazole derivatives, strobilurins, carbamate (including thiocarbamate), benzimidazoles (thiabendazole), N-trihalomethylthio compounds (captan), substituted benzenes, carboxamides, phenylamides and phenylpyrroles, and mixtures thereof; an insecticide (such as neonicotinoids, carbamates and pyrethroids), acaricide, molluscicide and a nematicide.

Preferred examples of suitable active ingredients (whether insecticide, nematicide or funigicide) for a composition of the invention are selected from abamectin (1), acephate (2), acetamiprid (4), alpha-cypermethrin (202), azinphos-methyl (45), bifenthrin (76), carbaryl (115), carboxin (120), carbofuran (118), carbosulfan (119), chlorpyrifos (145), clothianidin (165), cyromazine (209), deltamethrin (223), dimethoate (262), emamectin benzoate (291), endosulfan (294), fipronil (354), furathiocarb (412), gamma-HCH (430), imidacloprid (458), lsofenphos, methiocarb (530), omethoate (594), tefluthrin (769), thiamethoxam (792), thiacloprid (791), thiodicarb (799), azoxystrobin (47), pyraclostrobin (690), benomyl (62), bitertanol (84), captan (114), carbendazim (116), carboxin (120), chlorothalonil (142), copper salts (such as copper sulfate (172), cuprous oxide (181), Bordeaux mixture (87), copper hydroxide (169), copper sulfate (tribasic) (173), copper oxychloride (171) and copper octanoate (170)), cymoxanil (200), cyproconazole (207), cyprodinil (208), difenoconazole (247), diniconazole (267), ethirimol, famoxadone (322), fenamidone (325), fenhexamid (334), fenpiclonil (341), fluazinam (363), fludioxonil (368), fluquinconazole (385), flutolanil (396), flutriafol (397), fosetyl-aluminium (407), fuberidazole (409), guazatine (422), hexaconazole (435), hymexazol (447), imazalil (449), iprodione (470), isofenphos, mancozeb (496), maneb (497), metalaxyl (516), metalaxyl-M (517), metconazole (525), myclobutanil (564), silthiofam (729), nuarimol (587), oxadixyl (601), oxine-copper (605), oxolinic acid (606), pencycuron (620), prochloraz (659), procymidone (660), pyrimethanil (705), pyroquilon (710), quintozene (716), tebuconazole (761), tetraconazole (778), thiabendazole (790), thiophanate-methyl (802), thiram (804), triadimenol (815), triazoxide (821), triticonazole (842), trifloxystrobin (832), picoxystrobin (647) and ipconazole (468).

In an embodiment of either the first or second aspect, the active ingredient is selected from the active ingredients abamectin (1), emamectin benzoate (291), chlorpyrifos (145), metalaxyl-M (517), thiamethoxam (792), difenoconazole (247), azoxystrobin (47), tefluthrin (769), fludioxnil (368), imidacloprid (458), thiacloprid (791), fipronil (354), clothianidin (165), thiram (804) and myclobutanil (564).

Especially, the composition of the first aspect comprises Abamectin (1), and advantageously, the composition of the second aspect comprises, abamectin (1), emamectin benzoate (291), chlorpyrifos (145), thiamethoxam (792), tefluthrin (769), fludioxnil (368), imidacloprid (458), thiacloprid (791), fipronil (354), clothianidin (165) and thiram (804).

The pesticides are described in the e-Pesticide Manual, version 3.0, 13th Edition, Ed. CDC Tomlin, British Crop Protection Council, 2003-04. The number following the compound name is the entry number given in the Pesticide Manual.

Generally compositions of the first aspect come in a suspension concentrate (SC) or flowable suspension (FS) concentrate form. Suspension concentrate formulations for seed treatment, generally have a viscosity of 300 to 1200, such as 400 to 800, mPas-1, when measured in a BROOKFIELD viscometer with spindle 3 at 30 rpm and 25° C. The average size of the suspended particles is 0.1 to 20, especially 0.5 to 5, advantageously 1 to 3, microns, when measured with a laser particle analyzer, e.g., a Malvern Mastersizer S. Whereas, compositions of the second aspect tend to be a diluted version of the former.

The formulations, i.e., the compositions, preparations or combinations containing (A) and (B) components of the first aspect, are prepared in a known manner, for example, by intimately mixing and/or grinding the components with water.

The amount of surface active compounds (B) generally present range from 1 to 25, preferably 2.4 to 22.5, especially 5 to 10, %, by weight, based on the weight of the composition of the first aspect. Surface active compounds are made up of water soluble (hydrophilic) groups (or constituents), such as polyoxyethylene, and water insoluble (hydrophobic) groups (or constituents), such as polyoxypropylene. Examples of surface active compounds are surfactants having good emulsifying, dispersing and wetting properties, depending on the nature of the pesticide to be formulated. Surfactants will also be understood as meaning mixtures of surfactants. Surfactants are non-ionic, cationic and/or anionic.

The (B)(i) surface active compound preferably has a molecular weight of at least 100.

The (B)(ii) surface active compound preferably has a molecular weight of at most of 100,000.

In an embodiment, the weight ratio of surface active compounds (ii) to (i) is at most 10.

In an embodiment, two surface active compounds (B)(ii) are present in the composition.

In the event, two surface active compounds (B)(ii) are present:
the first surface active compound has a molecular weight of the hydrophobe constituent of from 2400 to 3900, preferably 3000 to 3800, such as 3200 to 3700 and, independent of the hydrophobe molecular weight, a proportion of the molecular weight of the hydrophile constituent of from 13 to 45, preferably 17 to 40, such as 18 to 30, %; and
the second surface active compound has a molecular weight of the hydrophobe constituent of from 2200 to 3900, preferably 2500 to 3600, such as 2700 to 3200 and, independent of the hydrophobe molecular weight, a proportion of the molecular weight of the hydrophile constituent of from 43 to 67, preferably 45 to 65, such as 50 to 60, %.

The Hydrophile-Lipophilic Balance (HLB) value is an index of the hydrophilic nature of a compound proposed by Griffin. The HLB value of a polyoxyethylene alkyl ether can be determined by, for example, the Griffin equation.
HLB value=[(molecular weight of the hydrophilic moiety)/(molecular weight of the surface active compound)]×20

Groups, for example, sulfate and phosphate ions, can also contribute to the HLB value.

Generally, compounds, including surface active compounds, that are commercially used tend to be not analytically pure, but a mixture of suitable compounds, for example, of the same chemistry but of different analogs, isomers and molecular weights. The characteristics attributed to, for example, the (B)(i) and (B)(ii) surface active compounds are, therefore, preferably also satisfied in a mixture of compounds where the characteristics are possessed by a compound in the mixture, which compound is present in a major proportion, such as greater than 50, preferably greater than 60, especially greater than 75, % by weight, based on the weight of the mixture; more preferably, the mixture itself satisfies the characteristics defined.

The surfactants customarily employed in formulation technology are described, inter alia, in the following publications:
“McCutcheon's Detergents and Emulsifiers Annual”, MC Publishing Corp., Glen Rock, N.J., 1988.
M. and J. Ash, “Encyclopedia of Surfactants”, Vol. I-III, Chemical Publishing Co., New York, 1980-1981.

Among the suitable surfactants there may be mentioned, e.g., polyacrylic acid salts, lignosulphonic acid salts, phenoisulphonic or (mono- or di-alkyl)naphthalenesulphonic acid salts, polystyrene sulfonate salts, laurylsulfate salts, polycondensates of ethylene oxide with lignosulphonic acid salts, polycondensates of ethylene oxide with fatty alcohols or with fatty acids or with fatty amines, substituted phenols (in particular alkylphenols or arylphenols such as mono- and di-(polyoxyalkylene alkylphenol) phosphates, polyoxyalkylene alkylphenol carboxylates or polyoxyalkylene alkylphenol sulfates), salts of sulphosuccinic acid esters, taurine derivatives (in particular alkyltaurides), polycondensates of ethylene oxide with phosphated tristyrylphenols and polycondensates of ethylene oxide with phosphoric esters of alcohols or phenols.

In an embodiment, the (B)(i) surface active compound is an ionic, advantageously an anionic, surfactant; preferably one or more (B)(i) surface active compound is selected from a sulfate type (e.g., an aryl sulfate) and a phosphate type (such as an alkylphenol polyalkoxyether phosphate, a block copolymer of polyalkoxyether phosphate, polyarylphenol polyalkoxyether phosphate and an arylphenol polyalkoxyether phosphate), especially a phosphate type surfactant (such as a polyarylphenol polyalkoxyether phosphate). Particularly desired in the compositions of the invention are that each (B)(i) surface active compound is of the same type, a preferred type is a phosphate type surfactant.

The anionic surfactants may be present as acids or include alkali metals (such as lithium, sodium and potassium), alkali earth metals (such as calcium and magnesium), ammonium and various amines (such as alkylamines, cycloalkylamines and alkanolamines).

Specific examples of suitable anionic surfactants include: Sorprophor PS19 (Rhodia), Dowafax 30 CO5 (Dow), Soprophor 4D384 (Rhodia) and Soprophor 3D33 (Rhodia).

In an embodiment, the (B)(ii) surface active compound is a polyalkylene oxide polymer, such as a block polymer. Specific examples are polyoxyethylene polyoxypropylene block polymers, and polyoxyethylene polyoxypropylene block polymer ethers. Specific examples include Toximul 8320 (Stepan), Emulsogen 3510 (Clariant), Antarox PUl122 (Rhodia), Pluronic L101 (BASF), Pluronic L122 (BASF) and Pluronic PE 10500 (BASF).

The compositions of the invention can also contain a wetting agent, which is also considered surface active compound in that it has a water soluble (hydrophilic) and water insoluble (hydrophobic) components, but they tend to non-ionic and generally have a molecular weight of less than 2000, and so can be a component according to (B)(i). In a preferred embodiment of the first aspect, a wedding agent is not present.

Advantageously, three surface active compounds, one of (B)(i) and two of (B)(ii), are used in the compositions according to the first aspect.

The compositions of the invention also may comprise at least one antifreeze agent. In an embodiment, the antifreeze agent is present in at least about 2 and up to about 25% of, more specifically from 3 to about 10% by weight, based on the weight of the composition of the first aspect.

Specific examples of suitable antifreezes include ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, and octaglycerol.

As a particularly preferred subset of suitable antifreeze materials there can be mentioned ethylene glycol, propylene glycol and glycerol.

The compositions of the invention optionally includes at least one polymer selected from water-soluble and water-dispersible film-forming polymers. Suitable polymers have an average molecular weight of at least about 7,000 up to about 200,000; more specifically at least about 10,000, up to about 100,000. The composition of the first aspect generally contain from about 0% to about 10% by weight of the composition of polymer. As used herein, “nonionic surfactants” are different compounds from the water-dispersible and water-soluble polymers described herein.

Suitable polymers are selected from

d1) ethylene vinylacetate copolymers,

d2) vinylacetate/vinylpyrrolidone copolymers,

d3) alkylated vinylpyrrolidone copolymers,

d4) polyvinylpyrrolidone, and

d5) polyalkyleneglycol including the polypropylene glycols and polyethylene glycols.

The compositions of the invention also optionally contains at least one thickener. In one embodiment, the thickener is present in an amount from about 0.01% to about 5% w/w, more specifically from 0.05 to 2% by weight, based on the weight of the composition of the first aspect.

Illustrative of thickeners (water-soluble polymers which exhibit pseudoplastic properties in an aqueous medium) are gum arabic, gum karaya, gum tragacanth, guar gum, locust bean gum, xanthan gum, carrageenan, alginate salt, casein, dextran, pectin, agar, 2-hydroxyethyl starch, 2-aminoethyl starch, 2-hydroxyethyl cellulose, methyl cellulose, carboxymethyl cellulose salt, cellulose sulfate salt, polyacrylamide, alkali metal salts of the maleic anhydride copolymers, and alkali metal salts of poly(meth)acrylate.

As suitable thickeners there may also be mentioned attapulgite-type clay, carrageenan, croscarmellose sodium, furcelleran, glycerol, hydroxypropyl methylcellulose, polystyrene, hydroxypropyl cellulose, hydroxypropyl guar gum, and sodium carboxymethylcellulose. Xanthan gum and attapulgite-type clay are preferred.

The compositions of the invention can be employed together with the adjuvants customary in formulation technology, biocides, biostats, emulsifiers (lethicin, sorbitan, and the like), antifoam agents or application-promoting adjuvants customarily employed in the art of formulation. In addition, there may be mentioned inoculants and brighteners.

Additionally, a colouring agent, such as a dye or pigment, is included in the seed coating so that an observer can immediately determine that the seeds are treated. The colouring agent is also useful to indicate to the user the degree of uniformity of the coating applied. Generally, the colouring agent tends to have a melting point above 30° C., and therefore, is also suspended in the compositions of the present invention.

The compositions of the invention can be prepared by processes known in the art, such as forming a homogeneous suspension with all the components, except the thickeners, and wet milling the suspension until the desired particle size is reached, then the thickeners and further water are added to a set viscosity.

The final composition can be screened if desired to remove any insoluble particles.

In one embodiment, commercial products according to the first aspect will preferably be formulated as concentrates (also known as “formulated products”, “pre-mix”). They may be used undiluted or may be diluted with a liquid carrier, such as water, and one or more components in a tank before using. The decision to dilute (by adding other components or liquid carrier) depends on the treatment methods available to the user. The composition according to the second aspect is an example of diluting the composition of the first aspect. The liquid carrier in the slurry composition (also known as “ready to apply” or “tank-mix”) tends to water.

The pesticidal composition of the first aspect may be used alone or in combination with other pesticidal compositions for treatment of plant propagation material either together or sequentially.

Generally, a composition containing a variety of components tend to interact with each other and affect the physical characteristics of that composition, such as an increase in the sedimentation and a change in the viscosity over time and/or climatic conditions of storage. Accordingly, compositions that exhibit good storage characteristics so that they can be transported long distances and kept in store-houses are also desired. It has been found that the composition of the first aspect also demonstrate such improved physical characteristics.

Further, in an embodiment of the composition of the first aspect a polymer component is excluded from the composition because it has been found to affect the physical characteristics of the composition on storage. However, a polymer may be used in combination with the composition of the first aspect in a slurry composition of the second aspect (also known as a tank mix) to provide additional coating properties before application to the propagation material because in such an event the resulting composition does not tend to be stored and also, optionally, compatibility agents may be used. In the event a polymer is used in a slurry composition, the polymer is generally present in an amount of from 1 to 7, such as 2 to 6, % by weight, based on the weight of the composition of the first aspect.

Generally, a composition of the second aspect is that applied for controlling pests, such as by treating propagation material. In such an event, such a composition would contain more types of formulation components, than a composition of the first aspect, which is an ingredient in the preparation of the composition of the second aspect.

Uses

The compositions of the present invention can be used to control pests from plants by conventional methods.

The pesticidal compositions according to first and second aspects are particularly suited to for the treatment of plant propagation material so that material has a degree of protection during its germination and growth.

The term “plant propagation material” is understood to denote all the generative parts of the plant, such as seeds, which can be used for the multiplication of the latter and vegetative plant material such as cuttings and tubers (for example, potatoes). There may be mentioned, e.g., the seeds (in the strict sense), roots, fruits, tubers, bulbs, rhizomes, parts of plants. Germinated plants and young plants, which are to be transplanted after germination or after emergence from the soil, may also be mentioned. These young plants may be protected before transplantation by a total or partial treatment by immersion.

The pesticidal compositions according to first and second aspects are especially suited to treatment of seeds. The techniques of seed treatment application are well known to those skilled in the art, and they may be used readily in the context of the present invention. For the purposes of this invention, seed treatments are defined as chemical or biological substances that are applied to seeds or vegetative plant propagation materials to control disease organisms, insects, or other pests. The seed treatment composition includes the pesticides, such as fungicides, bactericides, nematicides and other classes of insecticides. Most seed treatments are applied to true seeds, which have a seed coat surrounding an embryo. However, some seed treatments can be applied to vegetative plant propagation materials such as rhizomes, bulbs, corms or tubers.

The composition of the first aspect may be used, for example, for treatment, in an undiluted form or be diluted with a liquid carrier, for example. In the instance it is diluted, such compositions are known as slurries or tank mix and represent an example of the second aspect of the invention. The compositions of the first and second aspect may be applied to a seed to result in a film (or dressing), a coating, or a pellet, of the pesticide on the seed after drying, depending on the treatment process. The processes are well known in the art, and employ, for seeds, e.g., the techniques of film-coating or encapsulation, or for the other propagation material, the techniques of, e.g., immersion. Needless to say, the method of application of the compounds to the seed may be varied and the invention is intended to include any technique which is to be used.

The compositions of the invention are formulated for protecting cultivated plants and their propagation materials. The compositions are advantageously formulated for seed treatment applications against soil inhabiting insects, which can damage the crop in the early stages of plant development. For example, the compositions can be formulated to target insects and representatives of the order Acarnia including:

from the order Lepidoptera, for example, Acleris spp., Adoxophyes spp., Aegeria spp., Agrotis spp., Alabama argillaceae, Amylois spp., Anticarsia gemmatalis, Archips spp., Argyrotaenia spp., Autographa spp., Busseola fusca, Cadra cautella, Carposina nipponensis, Chilo spp., Choristoneura spp., Clysia ambiguella, Cnaphalocrocis spp., Cnephasia spp., Cochylis spp., Coleophora spp., Crocidolomia binotalis, Cryptophlebia leucotreta, Cydia spp., Diatraea spp., Diparopsis castanea, Earias spp., Ephestia spp., Eucosma spp., Eupoecilia ambiguella, Euproctis spp., Euxoa spp., Grapholita spp., Hedya nubiferana, Heliothis spp., Hellula undalis, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiella, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusia ni and Yponomeuta spp.;

from the order Coleoptera, for example,

Agriotes spp., Anthonomus spp., Atomaria linearis, Chaetocnema tibialis, Cosmopolites spp., Curculio spp., Dermestes spp., Diabrotica spp., Epilachna spp., Eremnus spp., Leptinotarsa decemlineata, Lissorhoptrus spp., Melolontha spp., Orycaephilus spp., Otiorhynchus spp., Phlyctinus spp., Popillia spp., Psylliodes spp., Rhizopertha spp., Scarabeidae, Sitophilus spp., Sitotroga spp., Tenebrio spp., Tribolium spp. and Trogoderma spp.,;

from the order Orthoptera, for example,

Blatta spp., Blattella spp., Gryllotalpa spp., Leucophaea maderae, Locusta spp., Periplaneta spp. and Schistocerca spp.;

from the order Isoptera, for example,

Reticulitermes spp.;

from the order Psocoptera, for example,

Liposcelis spp.;

from the order Anoplura, for example,

Haematopinus spp., Linognathus spp., Pediculus spp., Pemphigus spp. and Phylloxera spp.;

from the order Mallophaga, for example,

Damalinea spp. and Trichodectes spp.;

from the order Thysanoptera, for example,

Frankliniella spp., Hercinothrips spp., Taeniothrips spp., Thrips palmi, Thrips tabaci and Scirtothrips aurantii;

from the order Heteroptera, for example,

Cimex spp., Distantiella theobroma, Dysdercus spp., Euchistus spp., Eurygaster spp., Leptocorisa spp., Nezara spp., Piesma spp., Rhodnius spp., Sahlbergella singularis, Scotinophara spp. and Triatoma spp.;

from the order Homoptera, for example,

Aleurothrixus floccosus, Aleyrodes brassicae, Aonidiella spp., Aphididae, Aphis spp., Aspidiotus spp., Bemisia tabaci, Ceroplaster spp., Chrysomphalus aonidium, Chrysomphalus dictyospermi, Coccus hesperidum, Empoasca spp., Eriosoma larigerum, Erythroneura spp., Gascardia spp., Laodelphax spp., Lecanium corni, Lepidosaphes spp., Macrosiphus spp., Myzus spp., Nephotettix spp., Nilaparvata spp., Paratoria spp., Pemphigus spp., Planococcus spp., Pseudaulacaspis spp., Pseudococcus spp., Psylla spp., Pulvinaria aethiopica, Quadraspidiotus spp., Rhopalosiphum spp., Saissetia spp., Scaphoideus spp., Schizaphis spp., Sitobion spp., Trialeurodes vaporariorum, Trioza erytreae and Unaspis citri;

from the order Hymenoptera, for example,

Acromyrmex, Afta spp., Cephus spp., Diprion spp., Diprionidae, Gilpinia polytoma, Hoplocampa spp., Lasius spp., Monomorium pharaonis, Neodiprion spp., Solenopsis spp. and Vespa spp.;

from the order Diptera, for example,

Aedes spp., Antherigona soccata, Bibio hortulanus, Calliphora erythrocephala, Ceratitis spp., Chrysomyia spp., Culex spp., Cuterebra spp., Dacus spp., Drosophila melanogaster, Fannia spp., Gastrophilus spp., Glossina spp., Hypoderma spp., Hyppobosca spp., Liriomyza spp., Lucilia spp., Melanagromyza spp., Musca spp., Oestrus spp., Orseolia spp., Oscinella frit, Pegomyia hyoscyami, Phorbia spp., Rhagoletis pomonella, Sciara spp., Stomoxys spp., Tabanus spp., Tannia spp. and Tipula spp.;

from the order Siphonaptera, for example, Ceratophyllus spp. und Xenopsylla cheopis and

from the order Thysanura, for example, Lepisma saccharina;

crucifer flea beetles (Phyllotreta spp.), root maggots (Delia spp.), cabbage seedpod weevil (Ceutorhynchus spp.) and aphids; and

from the order Acarina, for example, Acarus siro, Aceria sheldoni, Aculus schlechtendali, Amblyomma spp., Argas spp., Boophilus spp., Brevipalpus spp., Bryobia praetiosa, Calipitrimerus spp., Chorioptes spp., Dermanyssus gallinae, Eotetranychus carpini, Eriophyes spp., Hyalomma spp., Ixodes spp., Olygonychus pratensis, Ornithodoros spp., Panonychus spp., Phyllocoptruta oleivora, Polyphagotarsonemus latus, Psoroptes spp., Rhipicephalus spp., Rhizoglyphus spp., Sarcoptes spp., Tarsonemus spp. and Tetranychus spp.

Protection of developing plants against attack by plant parasitic nematodes is also obtainable in the instance the pesticide is, for example, Abamectin. Abamectin is effective against a wide range of nematode pests including species of Meloidogyne (for example, Meloidogyne incoginita and Meloidogyne javanica), Heterodera (for example, Heterodera glycines, Heterodera schachtii, Heterodora avenae and Heterodora trifolii), Globodera (for example, Globodera rostochiensis), Radopholus (for example, Radopholus similes), Rotylenchulus, Pratylenchus (for example, Pratylenchus neglectans and Pratylenchus penetrans), Aphelenchoides, Helicotylenchus, Hoplolaimus, Paratrichodorus and Tylenchorhynchus, in particular Meloidogyne.

The composition of the first and second aspect, in the case abamectin is present as a pesticide, are particularly effective in controlling nematodes.

Optionally, in addition to the control of insect pests, the compositions of the invention advantageously are formulated with fungicides for seed treatment applications against diseases in the soil, which mostly occur in the early stages of plant development. For example, the compositions can be formulated to target pathogens including Pythium, Tilletia, Gerlachia, Septoria, Ustilago, Fusarium, Rhizoctonia (so-called “damping off complex”); Oomycetes such as Phytophthora, Plasmopara, Pseudoperonospora, Bremia etc. as well as against the Botrytis species, Pyrenophora, Monilinia and further representatives of the Ascomycetes, Deuteromycetes and Basidiomycetes classes.

Suitable target crops are especially potatoes, cereals, (wheat, barley, rye, oats), rice, maize, sugar beet, cotton, millet varieties, sorghum, tobacco, sun flowers, beans, peas, oil plants (rape, canola), soybeans, cabbages, tomatoes, eggplants (aubergines), pepper and other vegetables, and spices as well as ornamental shrubs and flowers.

Suitable target crops also include transgenic crop plants of the foregoing varieties. The transgenic crop plants used according to the invention are plants, or propagation material thereof, which are transformed by means of recombinant DNA technology in such a way that they are—for instance—capable of synthesizing selectively acting toxins as are known, for example, from toxin-producing invertebrates, especially of the phylum Arthropoda, as can be obtained from Bacillus thuringiensis strains; or as are known from plants, such as lectins; or in the alternative capable of expressing a herbicidal or fungicidal resistance.

Examples of such toxins, or transgenic plants which are capable of synthesizing such toxins, have been disclosed, for example, in EP-A-0 374 753, WO 93/07278, WO 95/34656, EP-A-0 427 529 and EP-A-451 878 and are incorporated by reference in the present application.

The compositions are suited for dressing applications on plant propagation material. The latter term embraces seeds of all kinds (fruit, tubers, grains), cuttings, cut shoots and the like. The preferred field of application is the treatment of all kinds of seeds (as specified in the target crops above), and in particular the seed treatment of canola, maize, cereals, cotton, tomatoes, tobacco, soybeans, other legumes, and other vegetables and crops that are susceptible, especially preferred are vegetable crop seeds.

As noted above, the compositions of this invention may be formulated or mixed in the seed treater tank or combined on the seed by overcoating with other pelleting materials and/or seed treating agents. The agents to be mixed with the compounds of this invention may be for the control of pests, nutrition, and the control of plant diseases.

The composition has particular application to concurrent and sequential seed treatments.

Seeds treated with the compositions of the invention generally have a drying time ranging from 20 to 60 seconds when being treated at room temperature. Generally, for vegetable seeds a spray drying technique is used.

The composition according to the first aspect may contain or be applied sequentially with further compounds on to the propagation material, such as a seed to form a seed coating or a pellet of the seed. These further compounds can be fertilizers or micronutrient donors or other preparations that influence plant growth. They can also be selective herbicides, fungicides, other insecticides, bactericides, insect growth regulators, plant growth regulators, nematicides, molluscicides or mixtures of several of these preparations.

Accordingly, a seed coating composition, particularly effective in the pelleting of seeds, is a preferred embodiment of the compositions of the first and second aspects.

A preferred method of applying the composition according to the invention consists in spraying or wetting the plant propagation material with the liquid preparation, or mixing the plant material with such liquid preparation. Also, before the application, the composition of the invention may be diluted with water by simple mixing at ambient temperature in order to prepare an on-farm seed treatment formulation.

The formulation may be applied, for low value crops, such as cereals, at application volumes ranging from 200 ml to 3 liters per 100 kg seed, more specifically, from 400 ml to 2 liters per 100 kg seed. For vegetable crop seeds, the amount tend to be higher.

A beneficial feature of the composition is that it provides an increased adherence of particles, in particular air-borne particles, to the seed, which results in decreased dustiness and the subsequent elimination of related dust problems. Elimination of the dust associated with many seed treatments also eliminates the associated health hazards to those who work with treated seeds, such as processing plant employees, truck drivers, warehouse workers, and farmers. The compositions of the present invention also enable satisfactory flowability & individuality of the propagation material (i.e., allow the material to be easily handled and not stick to each other).

Still another advantage of this invention is the uniform coating of seeds with non-dusting seed treatment which will not interfere with germination and sprouting of the seed but which will protect the seed and resultant seedling against pests, particularly soil-borne pests.

The application of a the compositions according to the invention directly on a seed, seed piece or bare root dip treatment for early season crop protection has several distinct advantages both from an economic and environmental standpoint. By treating seeds, seed pieces or bare roots, preferably prior to planting or sowing, with a pesticide, for example, a nematicide in the case of Abamectin, the pesticide is concentrated at the site of pest, e.g., nematode, attack and, therefore, much less active ingredient on a per acre basis is required in comparison with conventional soil application. This not only makes pest control more economic, but also minimizes environmental disturbance and any adverse non-target effects.

As used in the present application, the embodiments of the features of the present invention are independent of each other, unless otherwise specified.

The following Examples are given by way of illustration and not by way of limitation of the invention.

### EXAMPLES

Examples A, B, C and 1 to 13 are prepared by mixing surfactants, neutraliser (if any), a defoaming agent, an antifreeze agent, and a bactericide with water until a homogeneous phase is achieved. Subsequently, a colour pigment (if any) and active ingredient are added and are mixed. The resulting mixture is then wet-milled through a so-called bead mill (Dyno, Drais, Premier for instance). The milling parameters are set in such a way that the average particle size of the resulting ground premix is within specifications (usually median particle size average below 1.5 um). Finally, the polymer (if any), thickening agent and a minor amount of water are added and the final product is mixed for at least 30 minutes.

Table 1 indicates their compositional details, with each composition containing identical amounts of defoaming agent, thickeners and bactericide. The numbers given in the Table are weight.

The formulations are treated onto wheat seeds by Hege seed treatment device and then the amount of dust given off is measured by placing the treated seeds in a steel drum with blades, which when the drum is rotated stimulates handling and conveying of the seeds. A precision airflow control system provides a constant flow of air that carries air borne particles through a coarse filter separator onto a filter. The dust quantity is measured by weighing the filter (results are tabulated in Table 1).

TABLE 1

| | Examples | | | | | | | | | | | | | | | |
|---|---|---|---|---|---|---|---|---|---|---|---|---|---|---|---|---|
| Component | A | B | 1 | 2 | 3 | 4 | C | 5 | 6 | 7 | 8 | 9 | 10 | 11 | 12 | 13 |
| Abamectin (85%) | 47.00 | 47.00 | 47.00 | 47.00 | 47.00 | 47.00 | 40.80 | 47.00 | 47.00 | 47.00 | 47.00 | 47.00 | 47.00 | 42.50 | 42.50 | 40.80 |
| anionic sulfate surfactant | | 2.00 | | | | | 3.00 | | | | | | | | | 3.00 |
| anionic phosphate surfactant | 2.00 | | 2.00 | 2.00 | 2.00 | 2.00 | | 2.00 | 2.00 | 2.00 | 2.00 | 2.00 | 2.00 | 2.00 | 2.00 | |
| conv. wetting agent | 1.00 | 1.00 | 1.00 | 1.00 | 1.00 | 1.00 | 2.00 | 1.00 | 1.00 | | | | | 1.00 | 1.00 | 2.00 |
| (alcohol ethoxylate) | | | | | | | | | | | | | | | | |
| polymeric non-ionic surfactant | | | | | | | | | | | | | | | | |
| dispersant (50% EO) | | | | | | | | | | | | | | | | |
| polymeric non-ionic surfactant | | | | | | | | | | | | | | | | |
| dispersant (10% EO) | | | | | | | | | | | | | | | | |
| polymeric non-ionic surfactant, | | | 2.00 | 2.00 | | | | | 4.00 | | 6.00 | | 6.00 | 6.00 | | |
| dispersant (20% EO) | | | | | | | | | | | | | | | | |
| polymeric non-ionic surfactant | 1.00 | 1.00 | | | 2.00 | 2.00 | | 4.00 | | 6.00 | | 6.00 | | | 6.00 | 5.00 |
| dispersant (60% EO) | | | | | | | | | | | | | | | | |
| neutralizer | 0.20 | 0.20 | 0.20 | 0.20 | 0.20 | 0.20 | | 0.20 | 0.20 | 0.20 | 0.20 | 0.20 | 0.20 | 0.20 | 0.20 | |
| antifreeze | 4.00 | 4.00 | 4.00 | 4.00 | 4.00 | 4.00 | 4.00 | 4.00 | 4.00 | 5.00 | 5.00 | 5.00 | 5.00 | 5.00 | 5.00 | 4.00 |
| colour pigment | | | | | | | | | | 0.50 | | | 0.50 | 0.50 | 0.50 | |
| 60% polymerdispersion in water | | | 4.00 | | | | 5.00 | | | | | | | | | |
| 60% polymerdispersion in water | | | | 4.00 | 4.00 | | | | | | | | | | | |
| water | 52.80 | 52.80 | 47.80 | 47.80 | 47.80 | 51.80 | 53.20 | 49.80 | 49.80 | 47.30 | 47.80 | 47.80 | 47.30 | 50.80 | 50.80 | 53.20 |
| (A) - Abamectin & other solids*, | 40.9 | 40.9 | 40.9 | 40.9 | 40.9 | 40.9 | 35.4 | 40.9 | 40.9 | 41.4 | 40.9 | 40.9 | 41.4 | 37.5 | 37.5 | 35.4 |
| (B) - total surfactant | 4.0 | 4.0 | 5.0 | 5.0 | 5.0 | 5.0 | 5.0 | 7.0 | 7.0 | 8.0 | 8.0 | 8.0 | 8.0 | 9.0 | 9.0 | 10.0 |
| surfactant (i) | 3.00 | 3.00 | 3.00 | 3.00 | 3.00 | 3.00 | 5.00 | 3.00 | 3.00 | 2.00 | 2.00 | 2.00 | 2.00 | 3.00 | 3.00 | 5.00 |
| surfactant (ii) | 1.00 | 1.00 | 2.00 | 2.00 | 2.00 | 2.00 | 0.00 | 4.00 | 4.00 | 6.00 | 6.00 | 6.00 | 6.00 | 6.00 | 6.00 | 5.00 |
| ratio of B/A | 0.10 | 0.10 | 0.12 | 0.12 | 0.12 | 0.12 | 0.14 | 0.17 | 0.17 | 0.19 | 0.20 | 0.20 | 0.19 | 0.24 | 0.24 | 0.28 |
| ratio of (ii)/(i) | 0.33 | 0.33 | 0.67 | 0.67 | 0.67 | 0.67 | 0.00 | 1.33 | 1.33 | 3.00 | 3.00 | 3.00 | 3.00 | 2.00 | 2.00 | 1.00 |
| Dust-off measurements | 17.8 | 22.4 | 12.80 | 12.40 | 12.20 | 12.90 | 20.5 | 12.9 | 10.60 | 8.90 | 8.7 | 9.9 | 10.20 | 5.20 | 5.80 | 2.8 |
| | g | g | g | g | g | g | g | g | g | g | g | g | g | g | g | g |

*these materials are considered, on drying of the seeds, to form solid particles on the seed

1. An aqueous seed treatment insecticidal and/or nematicidal composition in the form of a suspension comprising:
(A) at least one insecticide and/or nematicide in an amount of at least 3 weight %, based on the weight of the composition, and optionally at least one other substance which has a melting point above 30° C.; and
(B) at least two surface active compounds, wherein (i) at least one surface active compound has a molecular weight of less than 2200 and a Hydrophile-Lipophilic Balance (HLB) of at least 10 and (ii) at least one surface active compound is non-ionic, has a molecular weight of at least 2200, wherein 10 to 60% of the compound molecular weight contributes to the hydrophile constituent of the compound, and the molecular weight of the hydrophobe constituent of the compound is from 2000 to 10000;
provided that the weight ratio of (B):(A) is in the range 0.08 to 0.5, and the weight ratio of (ii):(i) is at least 0.5.

2. The composition of claim 1, wherein the ratio of (B):(A) is 0.1 to 0.3.

3. The composition of claim 1, wherein the ratio of surface active compounds (ii):(i) is in the range from 1 to 5.

4. The composition according to claim 1, wherein (B)(i) is ionic.

5. The composition according to claim 1, wherein (B)(i) has a molecular weight of less than 1700.

6. The composition according to claim 1, wherein (B)(i) has a HLB value in the range 10 to 25.

7. The composition according to claim 1, wherein (B)(ii) has a molecular weight in the range of 3000 to 7500.

8. The composition according to claim 1, wherein two surface active compounds (B)(ii) are present.

9. The composition according to claim 8, wherein the first surface active compound has a molecular weight of the hydrophobe consitituent of from 2400 to 3900 and, independent of the hydrophobe molecular weight, a proportion of the molecular weight of the hydrophile constituent of from 13% to 45%; and the second surface active compound has a molecular weight of the hydrophobe consitituent of from 2200 to 3900 and, independent of the hydrophobe molecular weight, a proportion of the molecular weight of the hydrophile constituent of from 43% to 67%.

10. The composition according to claim 1, wherein a (B)(i) surface active compound is selected from a sulfate type surfactant and a phosphate type surfactant.

11. The composition according to claim 1, wherein each (B)(ii) surface active compound is a polyalkylene oxide polymer.

12. The composition according to claim 11, where each copolymer is a block polymer.

13. The composition according to claim 1, wherein (A) is abamectin.

14. A slurry composition comprising the composition defined in claim 1, a liquid carrier and optionally (i) one or more formulation adjuvants, (ii) one or more other pesticidal compositions, each comprising at least one further pesticide, or both (i) and (ii).

15. A method of protecting plant propagation material from attack by pests by treating the material with a pesticidally effective amount of the composition claimed in claim 1.

16. A pest resistant plant propagation material comprising a plant propagation material treated with a pesticidally effective amount of the composition claimed in claim 1.

17. A method to improve the dust-off property of a plant propagation material, comprising treating the plant propagation material with a composition comprising:
at least two surface active compounds, wherein (i) at least one surface active compound has a molecular weight of less than 2200 and a Hydrophile-Lipophilic Balance (HLB) of at least 10 and (ii) at least one surface active compound is non-ionic, has a molecular weight of at least 2200, wherein 10 to 85% of the compound molecular weight contributes to the hydrophile constituent of the compound, and the molecular weight of the hydrophobe constituent of the compound is from 2000 to 10000;
provided that the weight ratio of the surface active compounds to one or more pesticides, and optionally at least one other substance which has a melting point above 30° C., in the pesticidal composition or slurry composition, is in the range 0.08 to 0.5, and the weight ratio of (ii):(i) is at least 0.5.

18. A pest resistant plant propagation material comprising a plant propagation material treated with a pesticidally effective amount of the composition claimed in claim 14.

19. The composition of claim 1, wherein the ratio of B:A is 0.15 to 0.25; the ratio of surface active compounds (ii):(i) is in the range of 2 to 3; wherein B(i) is anionic and has a molecular weight in the range of 600 to 1200; wherein B(i) has a HLB value in the range of 14 to 18; wherein B(ii) has a molecular weight in the range of 4500 to 6000 and wherein two surface active compounds B(ii) are present.
